(19) United States
(12) Patent Application Publication
(10) Pub. No.: US 2003/0158840 A1
(43) Pub. Date: Aug. 21, 2003

(54) Storage system for storing information, and search system for searching information

(76) Inventor: Frens Henri de Vries, Amersfoort (NL)

Correspondence Address: BLANK ROME LLP, THE FARRAGUT BUILDING SUITE 1000, 900 17TH STREET NW, WASHINGTON, DC, 20006, US

(21) Appl. No.: 10/221,483

(22) PCT Filed: Mar. 15, 2001
(86) PCT No.: PCT/NL01/00214

(51) Int. Cl. G06F 7/00

(52) U.S. Cl. 707/3

(57) ABSTRACT

The invention describes a search system with a database which is classified into a plurality of levels. At each level, an overview of the classes which lie one level lower and can be accessed from the current class is projected onto a screen. The user can reach one of these classes which lie one level lower at any time by clicking on the correct location in the overview provided. The overviews are projected onto a stationary background, which is divided into boxes, so that the background remains the same when moving to a subsequent level. At all levels, the number of classes which can be reached therefrom is equal. If this number is equal to 20, the database can contain 160,000 subjects which can be accessed by means of only four mouse clicks.

In general terms, the present invention relates to a system for storing subjects and to a search system which makes it easy to use a computer to search for subjects which have been input previously.

In particular, the present invention is suitable as a search system which a potential customer can use to search for a company which can supply him with specific goods or services. However, the present invention can also be applied in a broader sense, for example as a catalogue for goods.

Search systems for company advertisements are known per se, for example in the form of the yellow pages, whether in paper form or in the form of a CD-ROM or the like, which can be searched by means of a search program running on a computer. The basis of search systems of this type is formed by a file containing the names of many companies. Since the potential customer is searching for a specific company from the context of a specific phrasing, the company names are subdivided into classes which relate to the nature of the services or goods supplied by these companies. Then, the companies which supply goods or services within each class are listed in alphabetical order in this class. Although this makes it easy to search for a suitable supplier, the number of classes in a search system such as the yellow pages is particularly high. A problem in this context is that it is difficult to gain an overview of all the available classes in the search system, and consequently it is difficult for the party making the search to decide which class is applicable to his question.

It is an object of the invention to provide a search system which solves the above problem.

More particularly, it is an object of the present invention to provide a search system which makes it possible, using a computer, to reach a subject which has been searched for using only a small number of mouse clicks.

According to a significant aspect of the present invention, the search system comprises a database which has been classified into a plurality of levels. Each level offers access to a plurality of classes, and from a specific selected class it is always possible to access a plurality of sub-classes at a lower level. Consequently, the number of possible choices in each level is always limited to a manageable number.

Furthermore, the search system according to the present invention uses a screen, the classes or sub-classes which can be selected at each level always being presented on this screen. This may be in the form of a list with words positioned one below the other but, in a preferred embodiment according to the present invention, a plurality of selection boxes are projected onto the screen, each box containing a description of the class or sub-class associated with the box in question.

In this way, a good overview of the available classes is. provided at each level. A user can choose relatively quickly from the available classes and move to the following level which corresponds to this choice, or can observe that he has made an incorrect choice and can go back to the previous level.

It is therefore easy, by means of a sophisticated classification method, for a subject which is being searched for to be found quickly.

The present invention could be implemented in the form of a computer program which runs on any suitable computer, such as a personal computer (PC), in which case the database belonging to the search system is stored on a memory belonging to this personal computer, for example in the form of a hard disk or a CD-ROM. However, the present invention is also eminently suitable for implementation in a form in which the database is stored in a central memory, the search software running on any suitable computer, such as a PC, which is connected to the said central memory via a network, which network may be a local network, an intranet, or preferably the Internet.

Preferably, however, the present invention is implemented as a web application, in which the case the database is stored in a central memory and the search software runs on a central computer which is associated with this central memory. A user uses his own computer, for example a PC, to make remote contact, via a network which may be any suitable network but is preferably the Internet, with this central computer, and transmits instructions and/or selections via this network. Conversely, the central computer is used to present information to the user via the network in question. For the user, therefore, access to the combination of database and search software is comparable to access to a web page.

In order in this case to ensure that the time between the moment at which a user inputs his choice into his computer and the time at which the screen displays the new possible choices is as short as possible, it is desirable for the amount of data transferred from the central computer to the user computer to be limited as far as possible. This problem arises in particular in the case of graphic implementation, with a plurality of boxes containing text being displayed on the screen.

For this purpose, according to a further aspect of the present invention, the information on the screen is displayed in the form of a stationary background onto which variable text information is projected. The stationary background includes the division into boxes and can be displayed continuously on the screen. During use, it is then only necessary for the new text information which is to be projected onto the stationary background to be transmitted from the central computer, via the network.

The image information for the stationary background can be received, when the software is started up, from the said central memory, although it is also possible for this image information associated with the software to be stored in a memory associated with the user's PC. This will considerably speed up the operation of setting up an image when the software is started up.

According to a further aspect of the present invention, the background and the associated division into boxes is identical at each level, so that the number of boxes in the box division is identical at each level. In this case, the number of classes at each level is preferably identical, so that no boxes remain empty.

In a preferred embodiment in which the invention is implemented as a web application, the background bearing the division into boxes forms part of the background of the web page and therefore will automatically be recognized as such by the user's browser.

In principle, the number of classes per level can be selected as desired. However, to gain a manageable distribution of the classes over a screen, it is desirable for the number of classes on the one hand not to be too small and on the other hand not to be too large. Moreover, if the number of classes is relatively small, it will be impossible to produce an appropriate classification system, and it will be necessary to make a large number of choices in an “other” class at each level. On the other hand, if the number of classes is selected to be too large, the classification runs the risk of becoming too intricate, and it is also possible that there will be insufficient classes left at a specific level, i.e. empty boxes. A further problem is that if the number of classes becomes too large, it becomes more difficult to gain a rapid overview of the classes which are projected onto the screen, making it difficult to make a choice quickly.

The number of classes at each level is preferably in the range from 10 to 30. In an embodiment which is preferred in view of its suitability, the number of classes at each level is 20. If the database is then structured on four levels, it will be possible to access 160,000 items or subjects using only four mouse clicks.

The present invention is eminently suitable as an advertisement search system, in which the subjects are company advertisements, either in the form of advertising text or in the form of an Internet site. More particularly, a subject of this type could contain a reference to the home page of the Internet site of the company in question. However, the present invention is not restricted to this application area. More generally, the present invention can be used as a search help in a database containing subjects which can be classified by means of characteristic features, for example a catalogue.

These and other aspects, characteristics and advantages of the present invention will be explained in more detail by means of the following description of a preferred embodiment of a search system according to the invention with reference to the drawing, in which identical reference numerals denote identical or similar components and in which:

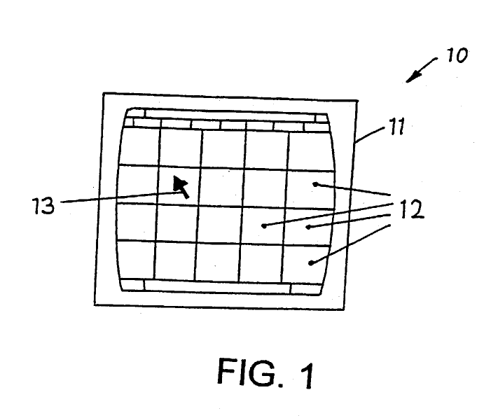

FIG. 1 diagrammatically depicts a screen and illustrates how, according to the present invention, an image is projected onto this screen;

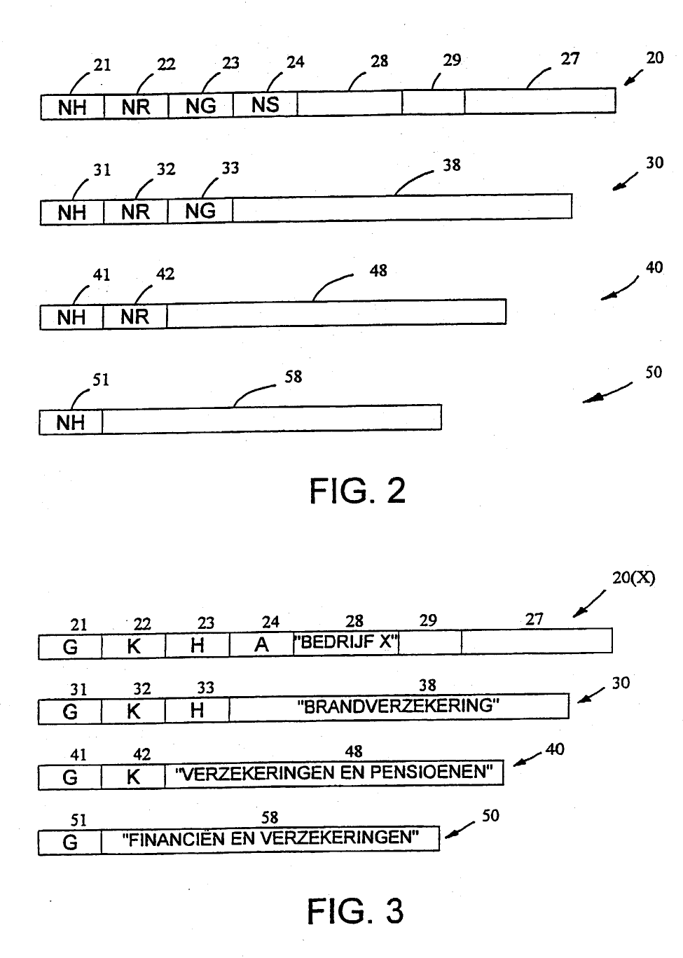

FIG. 2 illustrates the structure of an exemplary embodiment of a database according to the present invention;

FIG. 3 illustrates the content of a number of records in the database from FIG. 2 for an exemplary application;

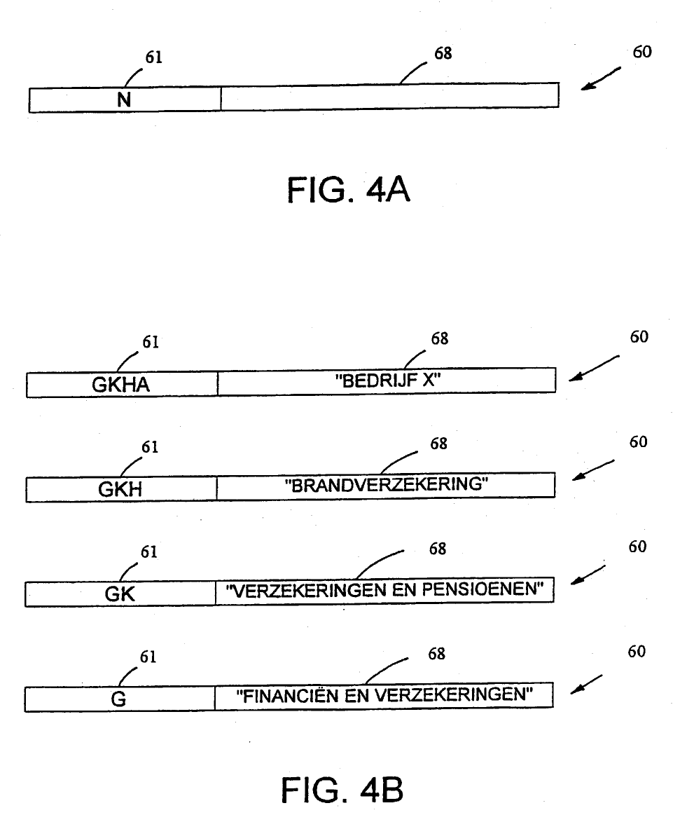

and FIGS. 4A-B illustrate an alternative structure of the database.

FIG. 1 illustrates a possible form in which information is presented to a user, specifically in the form of an image 10 on a screen 11 of a computer, which is not otherwise shown. The image 10 divides the screen 11 into a predetermined number of boxes 12, which number, in the example under discussion, is equal to 20. In the example shown in FIG. 1, the boxes 12 are distributed over the screen 11 in a 4×5 pattern, although a different pattern is also conceivable. The presentation on the screen 11 comprises a background which can be designed as desired and is not shown in the figure.

As is known per se, a computer system may be provided with a mouse device which can move a cursor 13 over the screen 11 to a box 12 which is to be selected by the user, after which this choice is input into the computer by depressing a click button arranged on the said mouse device (“mouse click”). Since a graphic method of inputting a choice of this type is known per se, it will not be explained in further detail here.

In the text which follows, the individual boxes 12 will be referred to as 12(i), the index i having a different value for the different boxes. If the screen 11 is divided into 20 boxes, the index i can therefore adopt a value of between 1 and 20. For the sake of clarity, however, in the text which follows this index will be referred to as a letter, the first box 12(i) being denoted as box 12(A) and the twentieth box being denoted as 12(T).

This method of designation can also be used to input a choice via a keyboard associated with the computer, which is likewise not shown in the figure for the sake of clarity. By way of example, instead of clicking on the first box 12(1) or 12(A), it is also possible for the user to press the letter A on the keyboard. Other input methods using the keyboard will also be possible, for example keyboard input using number keys, combinations with auxiliary keys, such as CTRL keys, etc.

A predetermined text is projected into each box. The text which is projected into a box 12(i) will be referred to below as {text} (i).

As has been stated, the present invention relates to a database which has been classified into a plurality of levels; the {text} (i) which is to be projected into each box 12(i) provides a description of the class which will be reached if the box 12(i) in question is selected by a mouse click or in some other way.

A possible structure of the database according to the present invention will also be explained with reference to FIG. 2, in an application for company advertisements. The use of the database according to the present invention will be explained for an exemplary situation in which a user is searching for a company from which he can purchase fire insurance.

The database according to the present invention comprises a subject record, which is denoted overall by the reference numeral 20, for each subject. For the sake of simplicity, in the present discussion the subject records will be provided with a serial number j, so that individual subject records are referred to as 20(j), it being possible in this example for j to adopt values of between 1 and 160,000. In this example, each subject (j) relates to a company advertisement of a predetermined length, which will include a company name, address information, telephone numbers and the like, and will include an advertising description of the company in question and the goods and/or services supplied by this company. Furthermore, they may also be a hyperlink to an Internet page, for example to the home page of the company in question.

By way of example, subject (j=X) relates to a company advertisement for an insurance company which arranges fire insurance.

A subject record 20 comprises a predetermined number of, in this example four, index fields 21, 22, 23 and 24, a first text field 27, a second text field 28 and a hyperlink field 29. If appropriate, the number of index fields may also be greater, in which case one or more index fields remain unused in this example.

The first index field 21 is referred to as a main class index field and contains a main class index, which is denoted by NH.

The second index field 22 is referred to as a sub-class index field and contains a sub-class index which is denoted by NR.

The third index field 23 is referred to as a group index field and contains a group index which is denoted by NG.

The fourth index field 24 is referred to as a subject index field and comprises a subject index which is denoted by NS.

The first text field 27, which is also referred to as the advertising text field, contains the advertising text of the subject in question.

The second text field 28, which is also referred to as the subject text field, contains text which will be referred to as the subject text. The subject text may, for example, be a predetermined subject name or a brief description of the subject in question.

The hyperlink field 29 contains any hyperlink to a predetermined Internet page.

Each index NH, NR, NG, NS in the four abovementioned index fields 21-24 may be a number with a value between 1 and 20 or a letter between A and T. The database can therefore contain 160,000 subject records 20. Each subject record 20 is uniquely characterized by a combination of the four indices NH, NR, NG, NS, meaning that each combination of four index values occurs only once and therefore uniquely defines a specific subject record 20(j).

In the illustrative example, it will be assumed that for subject (j=X) the main class index NH is equal to G, the sub-class index NR is equal to K, the group index NG is equal to H, and the subject index NS is equal to A. Furthermore, it will be assumed that the subject text in the second text field 28 of the subject record 20 (NH=G; NR=K; NG=H; NS=A) in question contains the text “COMPANY X”, that the first text field 27 of this subject record 20 (NH=G; NR=K; NG=H; NS=A) contains advertising text including address information for this COMPANY X, and that the hyperlink field 29 of this subject record 20 (NH=G; NR=K; NG=H; NS=A) contains a hyperlink to the home page of this COMPANY X.

According to the present invention, the subject records 20 are classified into clusters, referred to as groups, each comprising 20 subject records. In this example, therefore, there are 8000 groups. For subject records which belong to the same group, the values of NH, NR and NG are equal and the values of NS differ from one another. For each group, the database according to the present invention comprises a group record 30. A group record 30 comprises a main class index field 31 which includes the main class index NH, a sub-class index field 32 which includes the sub-class index NR, a group index field which includes the group index NG, and a text field 38 which includes text which will be referred to as the group text. The group text may, for example, be a predetermined group name or a brief description of the group in question.

In the illustrative example, it will be assumed that there is a group record 30 (NH=G; NR=K; NG=H), the text field 38 of which contains the text “fire insurance”.

According to the present invention, the group records 30 are classified into clusters, referred to as sub-classes, of at each level 20 group records. In this example, therefore, there are 400 sub-classes. For group records which belong to the same subclass, the values of NH and NR are equal and the values of NG differ from one another. For each sub-class, the database according to the present invention comprises a sub-class record 40. A sub-class record 40 comprises a main class index field 41 which includes the main class index NH, a sub-class index field 42 which includes the sub-class index NR, and a text field 48 which includes text which will be referred to as the sub-class text. The sub-class text may, for example, be a predetermined sub-class name or a brief description of the sub-class in question.

In the illustrative example, it will be assumed that there is a sub-class record 40 (NH=G; NR=K) of which the text field 48 contains the text “insurances and pensions”.

According to the present invention, the sub-class records 40 are classified into clusters, referred to as main classes, of at each level 20 sub-class records. In this example, therefore, there are 20 main classes. For sub-class records which belong to the same main class, the values of NH are equal and the values of NR differ from one another. For each main class, the database according to the present invention comprises a main class record 50. A main class record 50 comprises a main class index field 51 which includes the main class index NH, and a text field 58 which includes text which will be referred to as the main class text. The main class text may, for example, be a predetermined main class name or a brief description of the main class in question.

In the illustrative example, it will be assumed that there is a main class record 50 (NH=G), of which the text field 58 contains the text “finances and insurances”.

The database is searched as follows. After the search program has been started up, the user reaches the main level of the database, which is referred to as level 1, with the 20 main classes of the main level being projected onto the screen 11. More particularly, the text of the 20 text fields 58 (NH=A−T) is projected into the said boxes 12(i=A−T) on the screen 11. The value of the main class index NH always corresponds to the serial number i of the box 12(i) into which the text of the corresponding text field 58(NH) is projected.

In the illustrative example, therefore, the text “finances and insurances” is projected into the seventh box 12(G).

The user will choose a specific main class, for example by clicking in one of the boxes 12(i). The search program will then set the value of the main class index NH at i and will move to the second level of the database, which is referred to as level 2. (The same operations may take place if the user presses the corresponding letter.)

In the illustrative example, the user will understand that the service which he is looking for is covered by the category “finances and insurances”. He will therefore click in the seventh box 12(G) on the screen or will press the letter “G”.

The search program will then fix the value of the main class index NH at G.

At the second level of the database, the 20 sub-classes of the selected main class are projected onto the screen 11. More particularly, the text of the 20 text fields 48(NH; NR=A−T) in which the value of the main class index NH is equal to the value fixed in the previous step is projected into the said boxes 12(i=A−T) on the screen 11. The value of the sub-class index NR always corresponds to the serial number i of the field 12(i) into which the text of the corresponding text field 48(NH; NR=A−T) is projected.

In the illustrative example, therefore, the text “insurances and pensions” is projected into the eleventh box 12(K).

The user will reveal his choice of a specific sub-class, for example by clicking in one of the boxes 12(i). The search program will then fix the value of the sub-class index NR at i and will move to the third level of the database, which is referred to as level 3.

In the illustrative example, the user will understand that the service which he is looking for is covered by the category “insurances and pensions”. He will therefore click in the eleventh box 12(K) on the screen. The search program will then fix the value of the sub-class index NR at K.

At the third level of the database, the 20 groups of the selected sub-class are projected onto the screen 11. More particularly, the text of the 20 text fields 38 (NH; NR; NG=A−T) in which the values of the main class index NH and of the sub-class index NR are equal to the values fixed during the previous steps is projected into the said boxes 12(i=A−T) on the screen 11. In this case, the value of the group index NG always corresponds to the series number i of the field 12(i) into which the text of the corresponding text field 38(NH; NR; NG=A−T) is projected.

In the illustrative example, therefore, the text “fire insurance” is projected into the eighth box 12(H).

The user will indicate his choice of a specific group, for example by clicking in one of the boxes 12(i). The search program will then fix the value of the group index NG at i and will move onto the fourth level of the database, which is referred to as level 4.

In the illustrative example, the user will understand that the service which he is looking for is covered by the category “fire insurance”. He will therefore click in the eighth box 12(H) on the screen. The search program will then fix the value of the group index NG at H.

At the fourth level of the database, the 20 subjects of the selected group are projected onto the screen 11. More particularly, the text of the 20 subject text fields 28 (NH; NR; NG; NS=A−T) in which the values of the main class index NH, of the sub-class index NR and of the group class index NG are equal to the values fixed during the previous steps is projected into the said boxes 12(i=A−T) on the screen 11. In this case, the value of the subject index NS always corresponds to the series number i of the field 12(i) into which the text of the corresponding subject text field 28 (NH; NR; NG; NS=A−T) is projected.

In the illustrative example, therefore, the text “COMPANY X” is projected into the first box 12(A).

The user will indicate his choice of a specific subject, for example by clicking in one of the boxes 12(i). The search program will then fix the value of the subject index NS at i and will move onto the fifth level of the database, which is referred to as level 5.

In the illustrative example, the user will choose COMPANY X. He will therefore click in the first box 12(A) on the screen. The search program will then fix the value of the subject index NS at A.

The user then reaches the fifth level of the database, at which the advertising text of the advertising text field 27 of the subject selected is projected onto his screen 11. More particularly, the advertising text of the advertising text field 27 (NH; NR; NG; NS) in which the values of the main class index NH, of the sub-class index NR, of the group class index NG and of the subject index NS are equal to the values fixed during the previous steps is now projected onto the screen 11. Therefore, the user has reached the advertising text for the COMPANY X being searched for within four mouse clicks. This text may be more extensive than the amount which fits onto the screen and the user can scroll this text over his screen, as is known per se. Furthermore, he may be offered the option of printing this text. Therefore, an information file may be associated with the database, it being possible to select each file on the basis of the four index values.

If a hyperlink is stored in the corresponding hyperlink field 29(NH; NR; NG; NS), a hyperlink button is also projected onto the screen 11. If the user then clicks on this hyperlink button, he is “connected” to the web page indicated. Therefore, the user has reached the web page which has been searched for within a few mouse clicks.

As an alternative, it is possible for the hyperlink button to be projected as early as the fourth level into the relevant box 12(i), so that the user can click directly to the web page indicated from the fourth level and can skip the advertising text.

The database therefore comprises a main class file containing the main class records, a sub-class file containing the subclass records, a group file containing the group records and a subject file containing the subject records. In one possible embodiment, the software of the search program of the database is supplied to the user together with the main class file, the sub-class file and the group file, so that the user can store the main class text, the sub-class text and the group text on his own hard disk, which increases the speed of response of the program to a mouse click. The same would apply to the subject text, but in order to allow the operator of the database to add or remove advertisements, the subject records are preferably located in a database which is only accessible via the Internet.

An embodiment in which the main class file, the sub-class file, the group file and the subject file together with the software of the search program of the database are completely accessible via the Internet is also possible.

There is preferably a search module which is able to search for keywords in all the text fields. In this case, an input screen into which the user can type a search command is always projected onto the screen 11. After the text to be searched for has been typed in, the user gives a search command, after which the search module starts to search in the text fields 27, 28, 38, 48, 58, and, when the text searched for is found, jumps to the corresponding record.

Therefore, the present invention provides a search system having a database which is classified into a plurality of levels. At each level, an overview of the classes which lie one level lower and can be accessed from the current class is projected onto a screen. The user can access at each level one of these classes which lie at a lower level by clicking on the correct location in the overview on offer. The overviews are projected onto a stationary background, which is divided into boxes, so that the background remains the same when moving to the next level. In all the levels, the number of classes which can be accessed from this level is identical. If this number is equal to 20, the database can contain 160,000 subjects which can be accessed by means of only four mouse clicks.

It will be clear to a person skilled in the art that the scope of the present invention is not restricted to the examples which have been discussed above, but rather various alterations and modifications to these examples are possible without departing from the scope of the invention as defined in the appended claims.

Although there are advantages if the number of classes which can be reached is always identical, i.e. the maximum values for NH, NR, NG and NS are equal to one another (20 in the illustrative example which has been discussed), it is possible for the maximum values for NH, NR, NG and NS to differ from one another.

Furthermore, depending on requirements, it is possible for the maximum value for NH, NR, NG and NS to be greater or less than the exemplary value of 20: if this value is denoted by MAX(N), the number of text items which can be projected onto the screen at each level, and therefore the number of classes from which the user can choose, will in each case be equal to MAX(N).

Furthermore, it is possible, depending on requirements, for the number of class levels to be greater or less than the exemplary value of 4 which has been discussed. If the number of levels into which the database is classified is denoted by n, the number of subjects which the database can contain will be equal to MAX(N)ⁿ.

It will also be possible for the database to be structured in other ways and to achieve a similar effect using suitably adapted software.

In the preceding text, the text field 27 has been described, by way of example, as an advertising text field. More generally, the text field 27 may be referred to as a target text field, and this field may, instead of an advertisement for a company, contain a description of a product or service in a catalogue. If appropriate, it is possible, in an application which only intends to provide access to certain Internet pages, for the target text field to be omitted.

If the text which is to be included in a target text field 27 is too long for practical use, it is possible for subject records 20 to include a plurality of target text fields.

Furthermore, it is possible for the advertising text not to be stored as part of the subject records in the database, but rather to be stored on separate web pages, in which case the subject records comprise hyperlink fields, with hyperlinks which direct the user to the advertising pages, instead of text fields 27.

Furthermore, the subject records and/or the group records and/or the sub-class records and/or the main class records may be provided with additional hyperlink fields, with hyperlinks to, for example, a news page, or facility fields which are used to make specific facilities available, for example an SIC code, through which the registers of the Chambers of Commerce can be consulted.

Furthermore, in each of levels 2 onwards, it is possible for a BACK button to be projected onto the screen, in which case, if the user clicks on this button, he is returned to the previous level.

In the preceding text, the invention has been explained for an example in which the database is divided into four files, namely the main class file comprising 20 records, the sub-class file comprising 400 records, the group file comprising 8000 records and the subject file comprising 160,000 records, and the records in each of these files being provided with index fields, the number of index fields always increasing by one in the event of a transition to a subsequent level. The index in each index field may then always comprise a single character.

In an alternative embodiment, which is easier to program and more transparent in use, the database is not divided into files in this way, but rather comprises 168,420 records 60 which are equivalent to one another and each have one index field 61 and a text field 68, as illustrated in FIG. 4A. The records 60 all also comprise one or more hyperlink fields with the same objective and function as the hyperlink fields which have been discussed above, but this is not shown in FIG. 4A for the sake of simplicity. The index field 61 contains an index, which will be referred to as general index N.

For the 20 records which form part of the main level, the general index N has a length of one character, which character may adopt the values A to T inclusive.

For the 400 records which form part of the second level, the general index N has a length of two characters, it being possible for each character to adopt the values A to T inclusive, so that the general index N can then adopt the values AA to TT inclusive. For the 8000 records which form part of the third level, the general index N has a length of three characters, it being possible for each character to adopt the values A to T inclusive, so that the general index N can then adopt the values AAA to TTT inclusive. For the 160,000 records which form part of the fourth level, the general index N has a length of four characters, it being possible for each character to adopt the values A to T inclusive, so that the general index N can then adopt the values AAAA to TTTT inclusive.

If a user chooses the seventh box 12(G) as his first choice at the main level, the search software at the following level will project the text from the text fields 68 of the records bearing the indices GA to GT inclusive. Otherwise, the way of selecting and processing the choices is similar to that described above, as will be clear to a person skilled in the art.

For this alternative embodiment, FIG. 4B illustrates four records 60 at four successive levels, in which the general index N has the respective values G, GK, GKH and GKHA, as well as the text which is present in the text fields of these records, so that by comparison with FIG. 3 and the associated description it will be clear that the same result is achieved in this alternative embodiment. In fact, the four possible characters of the general index N can be considered to be equivalent to the indices which have been discussed above (i.e. the main class index, sub-class index, group index and subject index).

Obviously, it will be possible for the length of the index N to differ from the example described above. In a database with more levels, there may also be records for which the index has a length of five characters. In a database with a plurality of possible choices at each level, the length of the index for each subsequent level may increase by two (or more) characters.

1. Storage system for storing subjects in a database which can be accessed by a computer, comprising records (60), each record (60) comprising:
a text field (68);
at least one target text field and/or a hyperlink field;
and a classification index field (61) having a general index (N) for classifying the database into a plurality of levels.

2. Storage system according to claim 1, in which the database has a number of main class records, the general index (N) of the main class records preferably having a length of one character.

3. Storage system according to claim 2, in which the database has a number of sub-class records, the general index (N) of the sub-class records having a greater length than the general index (N) of the main class records, the difference preferably being one character.

4. Storage system according to claim 3, in which the database has a number of group records, the general index (N) of the group records having a greater length than the general index (N) of the sub-class records, the difference preferably being one character.

5. Storage system according to claim 4, in which the database has a number of subject records, the general index (N) of the subject records having a greater length than the general index (N) of the group records, the difference preferably being one character.

6. Storage system according to claim 5, in which the general index (N) of the group records has a length of four characters.

7. Storage system according to any one of the preceding claims, in which each character of the general index (N) can reach a maximum value, the maximum values of the different characters being identical to one another and these maximum values preferably being equal to 20.

8. Storage system, for storing subjects in a database which is accessible to a computer, comprising a subject file with subject records (20), each subject record (20) comprising:
a subject text field (28);
at least one target text field (27) and/or a hyperlink field (29);
and a plurality of classification index fields (21, 22, 23, 24) for classifying the database into a plurality of levels.

9. Storage system according to claim 8, in which the database also comprises a group file with group records (30),
each group record (30) comprising a group text field (38) and a predetermined number of classification index fields (31, 32, 33),
the number of classification index fields (31, 32, 33) of the group records (30) being one less than the number of classification index fields (21, 22, 23, 24) of the subject records (20).

10. Storage system according to claim 9, in which the database also comprises a sub-class file with sub-class records (40),
each sub-class record (40) comprising a sub-class text field (48) and a predetermined number of classification index fields (41, 42),
the number of classification index fields (41, 42) of the sub-class records (40) being one less than the number of classification index fields (31, 32, 33) of the group records (30).

11. Storage system according to claim 10, in which the database also comprises a main class file with main class records (50),
each main class record (50) comprising a main class text field (58) and a predetermined number of classification index fields (51),
the number of classification index fields (51) of the main class records (50) being less than the number of classification index fields (41, 42) of the sub-class records (40).

12. Storage system according to any one of claims 8-11, in which the number of classification index fields (21, 22, 23, 24) of the subject records (20) is equal to four.

13. Storage system according to any one of claims 8-12, in which the classification index fields (21, 22, 23, 24) of the subject records (20) contain respective classification indices (NH, NR, NG, NS) and in which the maximum values (MAX(NH), MAX(NR), MAX(NG), MAX(NS)) of the respective classification indices (NH, NR, NG, NS) are equal to one another, these maximum values preferably being equal to 20.

14. Computer program for using a computer provided with a screen (11) to search for information in a database which has been classified into a plurality of levels, which computer program allows a computer of this type to carry out the following operations:
an image (10) with a predetermined number of boxes (12) is projected onto the screen (11); and
at successive levels, a description of the classes of the next level which can be accessed from the relevant level is at each level projected into the boxes (12), it being possible for a user to indicate his selection by moving a cursor (13) to the appropriate box and inputting the choice into the computer by a mouse click, or by pressing one or more keys on a keyboard.

15. Computer program according to claim 14, in which at the penultimate level a description of the subjects of the next level which can be accessed from the penultimate level is at each level projected into the boxes (12).

16. Computer program according to claim 14 or 15, in which at the penultimate level a hyperlink associated with these respective subjects is at each level projected into the boxes (12).

17. Computer program according to claim 16, in which, if the user clicks in a box with a hyperlink, the computer seeks to connect to the Internet address or web page to which the hyperlink in question refers.

18. Computer program according to any one of claims 15-17, in which, if the user clicks in a box (12), outside a hyperlink which may be projected into this box, a target text associated with the selected subject, and possibly also a hyperlink associated with the selected subject, is projected onto the screen (11).

19. Computer program according to any one of claims 15-18, which is developed as a web application, designed to run on a central computer which can be accessed by a computer of a user via a network, such as the Internet.

20. Central computer which is programmed with a computer program according to any one of claims 14-19.

21. Search system, comprising:
a database which can be accessed by a computer, comprising:
main class records (50) with a main class index (NH);
sub-class records (40) with a main class index (NH) and a sub-class index (NR);
group records (30) with a main class index (NH), a subclass index (NR) and a group class index (NG);
subject records (20) with a main class index (NH), a subclass index (NR), a group class index (NG) and a subject index (NS);
the maximum values (MAX(NH), MAX(NR), MAX(NG), MAX(NS)) of the classification indices (NH, NR, NG, NS) being equal to one another, preferably being equal to 20;
and the search system also comprising a user computer which is provided with a screen (11), a central computer which can be accessed by the said user computer via a network, such as the Internet, and a central memory which is associated with the said central computer and contains the said database;
the said central computer being programmed to carry out the following operations:
an image (10) comprising a predetermined number of boxes (12), which is equal to the said maximum values (MAX(NH), MAX(NR), MAX(NG), MAX(NS)), is projected onto the screen (11) of the said user computer;
in a first search step, the text of text fields (58) of the main class records (50) is projected onto the screen (11) in the said boxes (12), the value of the main class index (NH) always corresponding to a serial number (i) of the box 12(i) into which the text of the corresponding text field (58) is projected;
when the choice of a user is input, the value of the main class index (NH) is fixed at a value (G) which corresponds to the user's choice;
in a second search step, the text of text fields (48) of those sub-class records (40) in which the value of the main class index (NH) is equal to the value (G) fixed in the previous step, the value of the sub-class index (NR) always corresponding to a serial number (i) of the field 12(i) into which the text of the corresponding text field (48) is projected, is projected into the said boxes (12) on the screen (11);
when the choice of a user is input, the value of the subclass index (NR) is fixed at a value (K) which corresponds to the user's choice;
in a third search step, the text of text fields (38) of those group records (30) in which the values of the main class index (NH) and the sub-class index (NR) are equal to the values (G, K) fixed during the previous steps, the value of the group index (NG) always corresponding to a serial number (i) of the field 12(i) into which the text of the corresponding text field (38) is projected, is projected into the said boxes (12) on the screen (11);
when the choice of a user is input, the value of the group index (NG) is fixed at a value (H) which corresponds to the user's choice;
in a fourth search step, the text of text fields (28) of those subject records (20) in which the values of the main class index (NH), the sub-class index (NR) and the group index (NG) are equal to the values (G, K, H) fixed during the previous steps, the value of the subject index (NS) always corresponding to a serial number (i) of the field 12(i) into which the text of the corresponding text field (28) is projected, is projected into the said boxes (12) on the screen (11);
when the choice of a user is input, the value of the subject index (NS) is fixed at a value (A) which corresponds to the user's choice;
and then the text of a target text field (27) of the subject record (20) in which the main class index (NH), the sub-class index (NR), the group index (NG) and the subject index (NS) are equal to the values (G, K, H, A) fixed during the previous steps is projected onto the screen (11), and/or a hyperlink of a hyperlink field (29) of the said subject record is projected onto the screen (11).

22. Search system according to claim 21, in which as early as the fourth step any hyperlinks of hyperlink fields (29) of the corresponding subject records are projected into the said boxes (12) on the screen (11).

23. Search system according to claim 21 or 22, in which, if the user clicks in a box with a hyperlink, the computer seeks to connect to the Internet address to which the hyperlink in question refers.
